(19) United States
(12) Patent Application Publication
(10) Pub. No.: US 2022/0223884 A1
(43) Pub. Date: Jul. 14, 2022

(54) HUMIDIFIER MODULE, HUMIDIFIER, FUEL CELL SYSTEM HAVING SUCH, AND METHOD FOR HUMIDIFYING A GAS

(71) Applicants: AUDI AG, Ingolstadt (DE); Volkswagen AG, Wolfsburg (DE)

(72) Inventors: Rune STAECK, Gifhorn (DE); Tore WESTPHAL, Meine (DE)

(21) Appl. No.: 17/605,926

(22) PCT Filed: Mar. 20, 2020
(86) PCT No.: PCT/EP2020/057714

§ 371 Date: Oct. 22, 2021

(30) Foreign Application Priority Data
Apr. 24, 2019 (DE) 10 2019 205 811.6

(51) Int. Cl. H01M 8/04119; H01M 8/04828

(52) U.S. Cl. CPC H01M 8/04149; H01M 8/04835

(57) ABSTRACT

A humidifier module for a humidifier in a fuel cell system is provided having a gas-permeable membrane, on one side of which there is arranged a flow field core defining a flow field, wherein the flow field core comprises at least two separating webs, between which a channel is formed. The separating webs are formed from a hygroscopic, not water-soluble material, such that a liquid flowing in the at least one channel can be stored temporarily in the hygroscopic separating webs. Furthermore, the invention relates to a humidifier having humidifier modules, a fuel cell system having a humidifier, and a method for humidifying a gas are also provided.

### BACKGROUND

### Technical Field

Embodiments of the invention relate to a humidifier module for a humidifier in a fuel cell system having a gas-permeable membrane, on one side of which there is arranged a flow field core defining a flow field, wherein the flow field core comprises at least two separating webs, between which a channel is formed. Furthermore, embodiments of the invention relate to a humidifier having a plurality of humidifier modules, a fuel cell system having a humidifier, and a method for humidifying a gas in a fuel cell system.

### Description of the Related Art

Humidifiers are used in general to bring about a transfer of moisture of two gaseous media having a different moisture content to the dryer medium. Such gas/gas humidifiers find application in particular in fuel cell devices, in which air with the oxygen contained therein is compressed in the cathode circuit to supply the cathode spaces of the fuel cell stack, so that relatively warm and dry compressed air is present, the moisture of which is not sufficient for use in the fuel cell stacks for the membrane electrode unit. The dry air provided by the compressor is humidified for the fuel cell stack by carrying it along a membrane permeable to water vapor, the other side of which is bathed in the humid vent air from the fuel cell stack. Furthermore, liquid water accrues in the cathode spaces and anode spaces. In order to ensure a sufficient water transfer through the humidifier membrane of the humidifier, humidifiers need to be relatively big in design. At the same time, enough liquid water must be provided for the humidifying.

DE 20 2011 109 654 U1 describes a membrane humidifier for fuel cells, having a frame with integrated or inserted flow fields formed by channel structures, the surfaces being coated to be hydrophilic and to prevent liquid accumulations, and to make possible a uniform distribution of the moisture on the gas being humidified.

US 2006/147773 A1 describes a humidifier with flow fields having a porous and hydrophilic structure, which can be secured as inserts in the frame with sealing at the margin.

DE 10 2014 205 029 A1 in turn describes a membrane humidifier having a flow field on the cathode side, comprising individual gas flow channels in which or on the walls of which a porous material or a fibrous structure is placed in order to take up a liquid.

### BRIEF SUMMARY

Embodiments of the invention provide a humidifier module, a humidifier, a fuel cell system and a method for humidifying a gas in which the design size of the humidifier can be reduced, while at the same time enabling a more effective humidifying.

The humidifier module is characterized in particular in that the separating webs are formed from a hygroscopic, not water-soluble material, such that a liquid flowing in the at least one channel can be stored temporarily in the hygroscopic separating webs. Thus, this makes it possible to take up liquid water from the fluid flow in the hygroscopic separating web, to store temporarily the liquid water so taken up in the hygroscopic separating web, and to give off the liquid water by evaporating into the fluid or gas flow moving through the channel. Hence, the liquid water normally given off discontinuously in the humidifier can be stored temporarily from the gas flow in the flow field and when need be it can be evaporated back into the gas flow, especially the cathode flow, and be taken up by the membrane in order to humidify it. This means that less water transfer is required through the membrane and therefore the membrane surface of the humidifier and so the design size of the humidifier can be reduced. Furthermore, the humidifier is stabilized by the at least two separating webs, which may brace the membrane on both sides. The separating webs formed from a hygroscopic material may have capillary-active properties, so that the liquid water is sucked up and distributed inside the separating web, so that the liquid water is distributed uniformly within the humidifier module or is present in uniformly distributed form. The hygroscopic material may be a silicate, for example, especially calcium silicate, or a zeolite.

In particular, the flow field core may be encased in a hydrophobic frame or the flow field core may be received in a hydrophobic carrier plate. The frame or the carrier plate made from a hydrophobic, i.e., not water-conducting material, hinders a water transport to the outside and thus seals off the flow field from the outside. The flow field core may be press-fitted in the hydrophobic carrier plate.

In order to create the largest possible flow field and in order to configure the humidifier module and thus the humidifier as small as possible, a plurality of hygroscopic separating webs may form channels separated from each other and the channels may extend in a straight line and parallel to each other. The straight extension of the channels ensures a low pressure loss inside the humidifier module. Furthermore, thanks to the plurality of separating webs, the storage capacity of the liquid water is further increased and the bracing of the membrane and hence the stability of the humidifier modules are improved. Moreover, the multitude of channels formed by the separating webs ensure a guiding of the fluid flow and the liquid water.

In an alternative embodiment, it is provided that a plurality of channels are present, separated from each other by hygroscopic separating webs, and the separating webs have at least one deflection. In other words, the separating webs may be curved or angled. In particular, it is provided that the separating webs have multiple deflections. By means of the deflections, the separating webs form surfaces on which water droplets can be separated. This increases the separation rate and makes possible a more effective storage of the liquid water in the hygroscopic separating webs.

In this regard, it is provided in particular that the separating webs have deflections at regular spacing from each other along their direction of extension and may be parallel to each other. This increases the separation rate.

The humidifier described herein for humidifying a gas for a fuel cell system having two end plates, on which there are formed an inlet for dry gas, an outlet for moistened gas, an additional inlet for humid gas and an additional outlet for dehumidified gas, is characterized in particular in that a plurality of already described humidifier modules are arranged between the end plates. The benefits and embodiments described for the humidifier module described herein apply also to the humidifier described herein, which is outfitted with a plurality of such humidifier modules.

The benefits and embodiments described for the humidifier and the humidifier module described herein apply also to the fuel cell system described herein, which is outfitted with such.

A separator may be present at the anode side, a drain of the separator may be fluid-mechanically connected to the humidifier, and/or a cathode vent gas line may be fluid-mechanically connected to the humidifier at the cathode outlet side. This allows using the liquid water which accrues on the anode side and/or the cathode side for the humidifying, so that the design size of the humidifier can be reduced.

The method for humidifying a gas in a fuel cell system having a fuel cell stack, which is fluidically connected to a humidifier as described above, involves in particular the following steps:
removing liquid water from the fuel cell stack and supplying the liquid water to the humidifier,
taking up at least a portion of the liquid water in the hygroscopic separating webs and temporary storing of this portion, and
at least partial emptying of the hygroscopic separating webs by evaporating the liquid water and humidifying the gas being supplied to the fuel cell stack by means of the evaporated liquid water.

This enables an efficient humidifying of the gas, especially the cathode gas, while at the same time having a smaller design size for the humidifier, since liquid water is temporarily stored in the hygroscopic separating webs and can be evaporated as needed into the cathode gas.

In particular, the liquid water may be removed from the fuel cell stack at the anode side and/or at the cathode side. The liquid water can be removed by active draining of liquid water from the fuel cell stack. In an alternative embodiment, the draining of liquid water from the fuel cell stack to fill the separating webs is continuous.

BRIEF DESCRIPTION OF THE SEVERAL VIEWS OF THE DRAWINGS

Further benefits, features and details are provided in the claims, the following description, and the drawings.

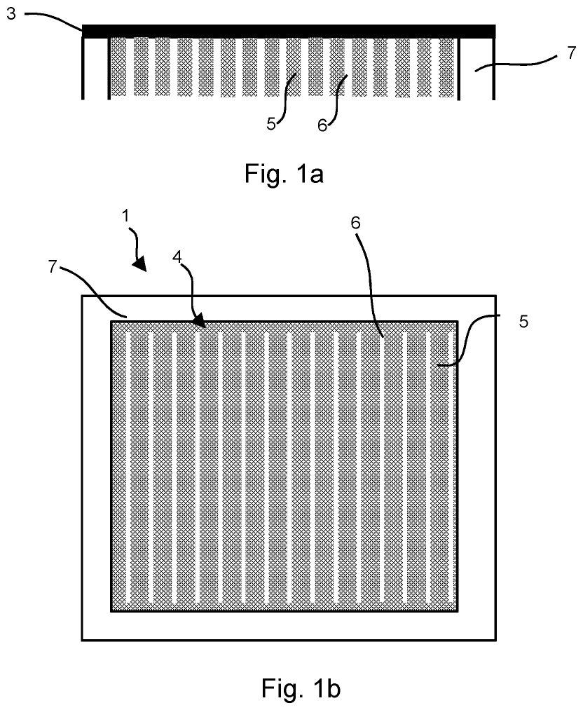

FIG. 1a shows a schematic representation of a humidifier module.

FIG. 1b shows a top view of the humidifier module from FIG. 1a with separating webs of straight configuration.

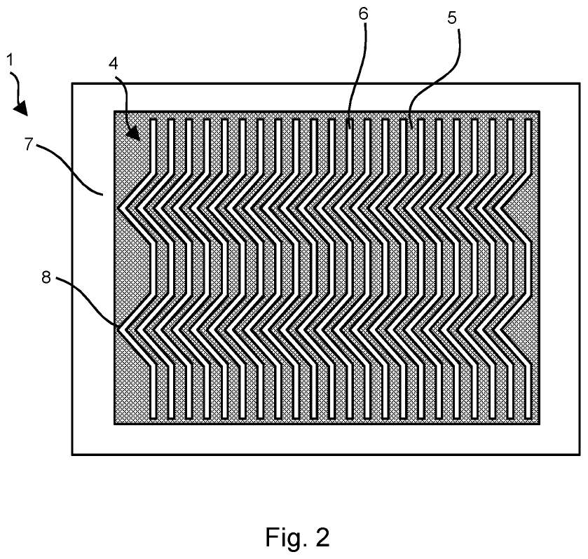

FIG. 2 shows a schematic representation of another humidifier module with separating webs having a deflection.

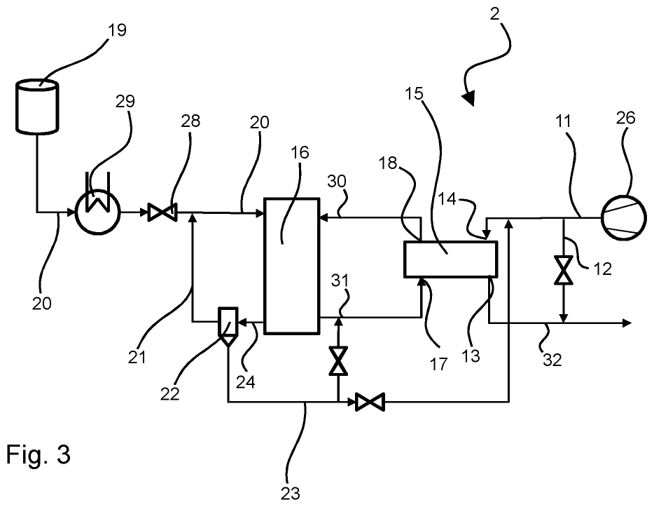

FIG. 3 shows a fuel cell system having a humidifier with a plurality of humidifier modules.

### DETAILED DESCRIPTION

FIG. 1a and FIG. 1b show a humidifier module 1 for a humidifier 15 having a gas-permeable membrane 3, on one side of which there is arranged a flow field core 4 defining a flow field. The flow field core 4 comprises a plurality of separating webs 5, between each of which there is formed a channel 6. The separating webs 5 are formed from a hygroscopic, not water-soluble material, especially calcium silicate, such that liquid water flowing in the channels 6 can be removed, taken up in the hygroscopic separating webs 5, temporarily stored there, and given off as needed by means of evaporation from the separating webs 5.

FIG. 1b illustrates how the flow field core 4 is surrounded by a hydrophobic frame 7. In the present instance, the flow field core 4 is press-fitted into a hydrophobic carrier plate. The hydrophobic frame 7 of the flow field core 4 hinders the escape of the liquid water from the flow field core 4 to the outside and thus seals off the flow field core 4.

The straight extension of the channels 6, formed parallel to each other, enables a guiding of the fluid moving therein, with little pressure loss. The separating webs 5 serve in addition as a support for the membrane 3 of the humidifier module 1 or the humidifier 15 and stabilize the humidifier module 1 or also the humidifier 15.

FIG. 2 shows an alternative embodiment, in which the channels 6 running between the hygroscopic separating webs 5 undergo several deflections 8. In the present instance, deflections 8 are formed at regular spacing from each other along the lengthwise extension of the separating webs 5, the individual separating webs 5 being arranged parallel to each other. The deflections 8 provide surfaces on which liquid droplets can be separated, so that liquid water can be removed from the fluid moving along the channels 6, taken up into the hygroscopic separating webs 5, and be stored temporarily therein.

FIG. 3 shows a fuel cell system 2 with a humidifier 15 for humidifying a gas. The humidifier 15 here has two not otherwise represented end plates, on which there are formed an inlet 14 for dry gas, an outlet 18 for moistened gas, an additional inlet 17 for humid gas and an additional outlet 13 for dehumidified gas. A plurality of the previously described humidifier modules 1 are arranged between the two end plates.

The fuel cell system 2 comprises, as its central component, a fuel cell stack 16, having a plurality of not otherwise represented fuel cells arranged in a stack. Each fuel cell is coordinated with an anode space as well as a cathode space, the anode and the cathode being separated from each other by an ionically conductive polymer electrolyte membrane.

Moreover, between every two such membrane electrode arrangements there is situated a not otherwise represented bipolar plate, which serves for the supplying of reactants to the anode and cathode spaces and also produces the electrical connection between the individual fuel cells.

In order to supply the fuel cell stack 2 with the reactants, i.e., the cathode gas and the fuel, the fuel cell stack 16 is connected at the anode side to an anode feed line 20 for supplying a hydrogen-containing anode gas from an anode reservoir 19. The anode operating pressure on the anode side of the fuel cell stack 16 can be adjusted by an actuator 28 in the anode feed line 20. At the anode outlet side there is an anode vent gas line 24, being connected fluid-mechanically to an anode recirculation line 21 for transporting away the unreacted anode gas, connected fluid-mechanically to the anode feed line 20. Furthermore, at the anode side, a separator 22 is present in the anode recirculation line 21, being in particular a water separator, whose drain is connected by means of a liquid feed line 23 upstream from the humidifier 15 to a cathode feed line 30. This allows the liquid water produced on the anode side to be supplied to the humidifier 15.

On the cathode side, the fuel cell stack 16 is connected to a cathode feed line 30 for supplying the oxygen-containing cathode gas. For the delivery and compression of the cathode gas, a compressor 26 is arranged in a part of the cathode feed line 30 configured as a dry feed line 11. In the embodiment shown, the compressor 26 is configured as a compressor 26 operated basically by an electric motor, being powered by a not otherwise represented electric motor designed with corresponding power electronics.

By the compressor 26, the cathode gas which is sucked in from the surroundings is taken to the humidifier 15 by means of the dry feed line 11. A second part of the cathode feed line 30 connects the humidifier 15 to the fuel cell stack 16 and carries moistened cathode gas to the cathode spaces of the fuel cell stack 16. Furthermore, liquid water and unreacted cathode gas is taken by the cathode vent gas line 31 back to the humidifier 15, or the unreacted cathode gas (especially the exhaust air) may be taken from the cathode spaces 18 of the fuel cell stack 16 to a not otherwise represented exhaust gas treatment. Finally, the humidifier 15 also has a humidifier drain line 32 for removal of dehumidified cathode exhaust gas.

The liquid feed line 23 can furthermore be connected fluid-mechanically to the cathode drain line 31 upstream from the humidifier 15. This likewise enables a supplying of liquid water to the humidifier 15, since the exhaust gas is additionally humidified before it enters the humidifier 15 and its humidifier module 1. Alternatively or additionally, a bypass line 12 may be present downstream from the compressor 26, being fluid-mechanically connected to the humidifier drain line 32.

The method for humidifying a gas in a fuel cell system 2 involves in particular the following steps. At first, liquid water is removed from the fuel cell stack 16 and supplied to the humidifier 15. The liquid water arises during the reaction of the fuel cell, which then leaves the fuel cell stack 16 in the form of vent gas and can be utilized in the humidifier 15. The supplying of liquid may also occur in addition on the anode side through the connected liquid feed line 23, which is fluid-mechanically connected to the dry feed line 11 and to the cathode drain line 31. The liquid water together with the cathode vent gas flows through the channels 6 of the humidifier module 1 of the humidifier 15 and is taken up and stored temporarily in the hygroscopic separating webs 5. The separating webs 5 can be at least partly emptied when necessary, especially when no further liquid water is being provided to the humidifier 15 or when the workload is heavy, by means of evaporation of the liquid water, so that the gas being supplied to the fuel cell stack 16 can be humidified.

The partial emptying can occur when the moisture of the membrane 3 falls below a given or predeterminable threshold value. This threshold value could be determined by means of an electrical conductivity of the humidifier 15. Alternatively, the liquid water can also be emptied automatically from the separating webs 5 at regular intervals. In another alternative embodiment, the separating webs 5 are emptied when no liquid water is being supplied or can be supplied from the fuel cell stack 16, or when the fuel cell system 2 is working in an operating mode with a higher water demand.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A humidifier module for a humidifier in a fuel cell system, comprising:
a gas-permeable membrane, on one side of which there is arranged a flow field core defining a flow field,
wherein the flow field core includes at least two separating webs and a channel formed between the separating webs, and
wherein the separating webs are formed from a hygroscopic material that is not water-soluble, such that a liquid flowing in the channel can be stored temporarily in the hygroscopic separating webs.

2. The humidifier module according to claim 1, wherein the flow field core is encased in a hydrophobic frame or the flow field core is received in a hydrophobic carrier plate.

3. The humidifier module according to claim 1, wherein a plurality of channels are present, separated from each other by hygroscopic separating webs, and the channels extend in a straight line and parallel to each other.

4. The humidifier module according to claim 1, wherein a plurality of channels are present, separated from each other by hygroscopic separating webs, and the separating webs have at least one deflection.

5. The humidifier module according to claim 4, wherein the hygroscopic separating webs have deflections at regular spacing from each other along their longitudinal direction of extension.

6. A humidifier for humidifying a gas for a fuel cell system, comprising:
two end plates, on which there are formed an inlet for dry gas, an outlet for moistened gas, an additional inlet for humid gas and an additional outlet for dehumidified gas; and
a plurality of humidifier modules arranged between the end plates, each of the humidifier modules including a gas-permeable membrane, on one side of which there is arranged a flow field core defining a flow field,
wherein the flow field core includes at least two separating webs and a channel formed between the separating webs, and
wherein the separating webs are formed from a hygroscopic material that is not water-soluble, such that a liquid flowing in the channel can be stored temporarily in the hygroscopic separating webs.

7. A fuel cell system having a fuel cell stack, to which cathode gas can be supplied on the cathode side and fuel can be supplied on the anode side, and having a humidifier according to claim 6 connected upstream from the fuel cell stack on the cathode side.

8. The fuel cell system according to claim 7, wherein a separator is present at the anode outlet side, a drain of the separator is fluid-mechanically connected to the humidifier, and/or a cathode vent gas line is fluid-mechanically connected to the humidifier at the cathode outlet side.

9. A method for humidifying a gas in a fuel cell system having a fuel cell stack, which is fluidically connected to a humidifier including two end plates, on which there are formed an inlet for dry gas, an outlet for moistened gas, an additional inlet for humid gas and an additional outlet for dehumidified gas, and a plurality of humidifier modules arranged between the end plates, wherein each of the humidifier modules includes a gas-permeable membrane, on one side of which there is arranged a flow field core defining a flow field, wherein the flow field core includes at least two separating webs and a channel formed between the separating webs, wherein the separating webs are formed from a hygroscopic material that is not water-soluble, such that a liquid flowing in the channel can be stored temporarily in the hygroscopic separating webs, the method comprising:
removing liquid water from the fuel cell stack and supplying the liquid water to the humidifier;
taking up at least a portion of the liquid water in the hygroscopic separating webs and temporarily storing this portion of the liquid water; and
at least partially emptying the hygroscopic separating webs by evaporating the liquid water and thereby humidifying the gas being supplied to the fuel cell stack.

10. The method according to claim 9, wherein the liquid water from the fuel cell stack is removed at the an anode side and/or at a cathode side of the fuel cell stack.
